(19) United States
(12) Patent Application Publication
(10) Pub. No.: US 2011/0184085 A1
(43) Pub. Date: Jul. 28, 2011

(54) TREAD RUBBER COMPOSITION FOR TWO-WHEELED VEHICLE TIRE AND TWO-WHEELED VEHICLE TIRE

(76) Inventor: Shigeki OTSUBO, Kobe-shi (JP)

(21) Appl. No.: 13/013,910

(22) Filed: Jan. 26, 2011

(30) Foreign Application Priority Data
Jan. 27, 2010 (JP) 2010-015622

(51) Int. Cl. C08L 7/00

(52) U.S. Cl. 523/156

(57) ABSTRACT

It is an object of the present invention to provide a tread rubber composition for a two-wheeled vehicle tire which can exhibit both good wet grip performance and good chunk resistance, and a two-wheeled vehicle tire including a tread produced using the rubber composition. The present invention relates to a tread rubber composition for a two-wheeled vehicle tire, including: a rubber component, silica, and carbon black, wherein the rubber component contains natural rubber, and styrene butadiene rubber and/or butadiene rubber, the silica has a CTAB specific surface area of 180 m²/g or more and a BET specific surface area of 185 m²/g or more, and the amount of the carbon black is 15 parts by mass or more per 100 parts by mass of the rubber component.

### TECHNICAL FIELD

The present invention relates to a tread rubber composition for a two-wheeled vehicle tire and a two-wheeled vehicle tire including a tread produced using the rubber composition.

### BACKGROUND ART

Rubber compositions for treads (tread rubbers) of two-wheeled vehicle tires are required to have high mechanical strength (chunk resistance) so as to prevent chunking (breaking away of pieces of rubber) from occurring during running. For this reason, carbon black which shows high reinforcing properties is generally included as a filler in the tread rubbers. However, tread rubbers including carbon black problematically tend to have inferior wet grip performance, which needs to be improved.

Patent Document 1 discloses the use of silica as a filler to improve wet grip performance. However, since silica gives lower reinforcement than carbon black, blending of silica while reducing the amount of carbon black tends to lower the mechanical strength of the tread rubber, and deteriorate chunk resistance. Therefore, improvement has been needed.
Patent Document 1: JP 2008-31244 A

### SUMMARY OF THE INVENTION

The present invention aims to provide a tread rubber composition for a two-wheeled vehicle tire which can exhibit both good wet grip performance and good chunk resistance. The present invention also aims to provide a two-wheeled vehicle tire including a tread produced using the rubber composition.

The present invention relates to a tread rubber composition for a two-wheeled vehicle tire, including: a rubber component, silica, and carbon black, wherein the rubber component contains natural rubber, and styrene butadiene rubber and/or butadiene rubber, the silica has a CTAB specific surface area of 180 m²/g or more and a BET specific surface area of 185 m²/g or more, and the amount of the carbon black is 15 parts by mass or more per 100 parts by mass of the rubber component.

The silica preferably has an aggregate size of 30 nm or more.

The present invention also relates to a two-wheeled vehicle tire including a tread produced using the rubber composition.

The two-wheeled vehicle tire can be suitably used as a motocross tire.

The tread rubber composition for a two-wheeled vehicle tire according to the present invention includes a specific rubber component, a certain amount of carbon black, and silica having a predetermined value or more of CTAB specific surface area and a predetermined value or more of BET specific surface area. Thus, it is possible to provide a two-wheeled vehicle tire that can exhibit excellent wet grip performance and chunk resistance.

### BRIEF DESCRIPTION OF THE DRAWINGS

FIG. 1 is a view illustrating a pore distribution curve.

### BEST MODE FOR CARRYING OUT THE INVENTION

The rubber composition of the present invention contains a specific rubber component, a certain amount of carbon black, and silica having a predetermined value or more of CTAB specific surface area and a predetermined value or more of BET specific surface area.

In the rubber composition of the present invention, natural rubber (NR), and styrene butadiene rubber (SBR) and/or butadiene rubber (BR) are used as the rubber component. In particular, combined use of NR and SBR is preferable because the combination results in good wet grip performance and breaking properties (chunk resistance).

The NR, SBR, and BR are not particularly limited, and each may be any of those generally used in the tire industry.

The NR content in 100% by mass of the rubber component is preferably 5% by mass or more, and more preferably 10% by mass or more. An NR content of less than 5% by mass tends to cause reduction in processability and cause deterioration in breaking properties. The NR content in 100% by mass of the rubber component is preferably 80% by mass or less, and more preferably 70% by mass or less. An NR content exceeding 80% by mass tends to cause reduction in wet grip performance.

The SBR content in 100% by mass of the rubber component is preferably 30% by mass or more, and more preferably 40% by mass or more. An SBR content of less than 30% by mass tends to cause reduction in wet grip performance. The upper limit of the SBR content is not particularly limited, and is preferably 95% by mass or less, and more preferably 90% by mass or less.

The total content of NR, SBR and BR in 100% by mass of the rubber component is preferably 60% by mass or more, more preferably 70% by mass or more, and further preferably 80% by mass or more. A total content of less than 60% by mass may cause deterioration in breaking properties. The upper limit of the total content is not particularly limited and may be 100% by mass.

The rubber composition of the present invention may contain rubbers other than NR, SBR and BR, such as epoxidized natural rubber (ENR), isoprene rubber (IR), styrene-isoprene-butadiene rubber (SIBR), ethylene-propylene-diene rubber (EPDM), chloroprene rubber (CR), and acrylonitrile butadiene rubber (NBR).

The rubber composition of the present invention contains silica having a CTAB specific surface area of 180 m²/g or more and a BET specific surface area of 185 m²/g or more (hereinafter, also referred to as “finely-divided silica”). Blending of the finely-divided silica in a rubber composition makes it possible to achieve high mechanical strength and at the same time secure wet grip performance.

The CTAB (cetyltrimethylammonium bromide) specific surface area of the finely-divided silica is 180 m²/g or more, preferably 190 m²/g or more, more preferably 195 m²/g or more, further preferably 197 m²/g or more, and particularly preferably 200 m²/g or more. If the CTAB specific surface area is less than 180 m²/g, a sufficient reinforcing effect may not be obtained. The CTAB specific surface area is preferably 600 m²/g or less, more preferably 500 m²/g or less, further preferably 300 m²/g or less, and particularly preferably 250 m²/g or less. If the CTAB specific surface area exceeds 600 m²/g, it may be difficult to disperse the silica in the rubber composition, and therefore breaking properties may be significantly deteriorated.

The CTAB specific surface area of silica is measured in conformity with ASTM D3765-92.

The BET specific surface area of the finely-divided silica is 185 m²/g or more, preferably 190 m²/g or more, more preferably 195 m²/g or more, further preferably 200 m²/g or more, particularly preferably 210 m²/g or more, and most preferably 220 m²/g or more. If the BET specific surface area is less than 185 m²/g, a sufficient reinforcing effect may not be obtained. The BET specific surface area is preferably 600 m²/g or less, more preferably 500 m²/g or less, further preferably 300 m²/g or less, and particularly preferably 260 m²/g or less. If the BET specific surface area exceeds 600 m²/g, it may be difficult to disperse the silica in the rubber composition, and therefore breaking properties may be significantly deteriorated.

The BET specific surface area of silica is measured in conformity with ASTM D3037-81.

The aggregate size of the finely-divided silica is preferably 30 nm or more, more preferably 35 nm or more, further preferably 40 nm or more, particularly preferably 50 nm or more, and most preferably 60 nm or more. The aggregate size thereof is preferably 100 nm or less, more preferably 80 nm or less, further preferably 70 nm or less, and particularly preferably 65 nm or less. The finely-divided silica having an aggregate size in such a range can give excellent reinforcement while having favorable dispersibility.

The aggregate size is also called an aggregate diameter or a maximum frequency Stokes equivalent diameter, and means a particle size in the case where a silica aggregate formed by aggregation of a plurality of primary particles is regarded as one particle. The aggregate size may be measured with a disk centrifugal sedimentation granulometric analysis apparatus such as BI-XDC (produced by Brookhaven Instruments Corporation), for instance.

Specifically, the aggregate size may be measured with BI-XDC by the following method.

Silica (3.2 g) and 40 mL of deionized water are introduced into a 50-mL tall beaker, and the beaker containing a silica suspension is placed into a crystallizer filled with ice. In the beaker, the suspension is deagglomerated with an ultrasonic probe (1500-W 1.9-cm VIBRACELL ultrasonic probe (produced by Bioblock, used at 60% of the maximum power output)) for 8 minutes to prepare a sample. The sample in an amount of 15 mL is introduced into a disk, stirred, and measured under the conditions of a fixed mode, an analysis time of 120 minutes, and a density of 2.1.

In the apparatus recorder, the values of the diameters passing at 16% by mass, 50% by mass (or median) and 84% by mass and the value of the Mode are recorded (the derivative of the cumulative granulometric curve gives a frequency curve, the abscissa of the maximum of which is known as the “Mode”).

By the disk centrifugal sedimentation granulometric analysis method, an average size (by mass) of the particles (i.e. aggregates), marked D_{w}, can be measured after the silica is dispersed in water by ultrasonic deagglomeration. After analysis (sedimentation for 120 minutes), the particle size distribution by mass is calculated by the granulometric analysis apparatus. The average size (by mass) of the particles (aggregate size), marked D_{w}, is calculated by the following equation:

$$log {D}_{w} = {\sum }_{1}^{n} {m}_{i} log {D}_{i} / {\sum }_{1}^{n} {m}_{i}$$

(In the formula, mᵢ is the total mass of the particles in the class of Dᵢ).

The average primary particle size of the finely-divided silica is preferably 25 nm or less, more preferably 22 nm or less, further preferably 17 nm or less, and particularly preferably 14 nm or less. The lower limit of the average primary particle size is not particularly limited, and is preferably 3 nm or more, more preferably 5 nm or more, and further preferably 7 nm or more. Although the finely-divided silica has such a small average primary particle size, it also has the aforementioned aggregate size and therefore a structure like that of carbon black. Accordingly, the silica dispersibility is more improved, and thus the reinforcement and chunk resistance can be further improved.

The average primary particle size of silica may be determined by observing the silica with a transmission or scanning electron microscope, measuring the sizes of 400 or more primary particles of the silica observed in the visual field, and then averaging the sizes of the 400 or more primary particles.

The D50 of the finely-divided silica is preferably 7.0 μm or less, more preferably 5.5 μm or less, and further preferably 4.5 μm or less. The finely-divided silica having a D50 exceeding 7.0 μm may not exhibit a sufficient reinforcing effect. The D50 of the finely-divided silica is preferably 2.0 μm or more, more preferably 2.5 μm or more, and further preferably 3.0 μm or more. The finely-divided silica having a D50 of less than 2.0 μm may have difficulty in dispersing.

The D50 as used herein is a median diameter of silica, than which 50% by mass of the particles are smaller.

The proportion of the finely-divided silica having a particle size larger than 18 μm relative to the total amount of the finely-divided silica is preferably 6% by mass or less, more preferably 4% by mass or less, and further preferably 1.5% by mass or less. Thereby, the silica is favorably dispersed, and desired performances are achieved.

The D50 of silica and the proportion of the silica having a specific particle size are determined by the following method.

The agglomeration of aggregates is estimated by granulometric measurement (by laser diffraction) carried out on a silica suspension previously deagglomerated by ultrasonication. In this method, the aptitude of the silica for deagglomeration is measured (deagglomeration of the silica particles of 0.1 to tens of microns). The ultrasonic deagglomeration is performed with a VIBRACELL sound wave generator (600 W, produced by Bioblock, used at 80% of the maximum power output) equipped with a probe having a diameter of 19 mm. The granulometric measurement is carried out by laser diffraction on a MALVERN Mastersizer 2000 granulometric analyzer.

More specifically, the measurement is carried out by the following method.

1 g of silica is weighed in a pill box (6 cm in height and 4 cm in diameter), deionized water is added thereto to give a mass of 50 g, and thereby an aqueous suspension containing 20 of silica (this suspension is homogenized by magnetic stirring for 2 minutes) is prepared. Subsequently, ultrasonic deagglomeration is performed for 420 seconds, all the homogenized suspension is introduced into the vessel of the granulometric analyzer, and thereafter granulometric measurement is performed.

The distribution width W of the pore volume of the finely-divided silica is preferably 0.3 or more, more preferably 0.7 or more, further preferably 1.0 or more, particularly preferably 1.3 or more, and most preferably 1.5 or more. The pore distribution width W is preferably 5.0 or less, more preferably 4.0 or less, further preferably 3.0 or less, and particularly preferably 2.0 or less. Such broad pore distribution leads to improvement in silica dispersibility and provides desired performances.

The distribution width W of the pore volume of silica may be measured by the following method.

The pore volume of the finely-divided silica is measured by mercury porosimetry. A silica sample is pre-dried in an oven at 200° C. for 2 hours. Subsequently, within five minutes after the sample is removed from the oven, the sample is put in a test receptacle, and degassed under vacuum. The pore diameter (AUTOPORE III 9420, porosimeter for powder technology) is calculated by Washburn's equation with a contact angle of 140° and a surface tension γ of 484 dynes/cm (or N/m).

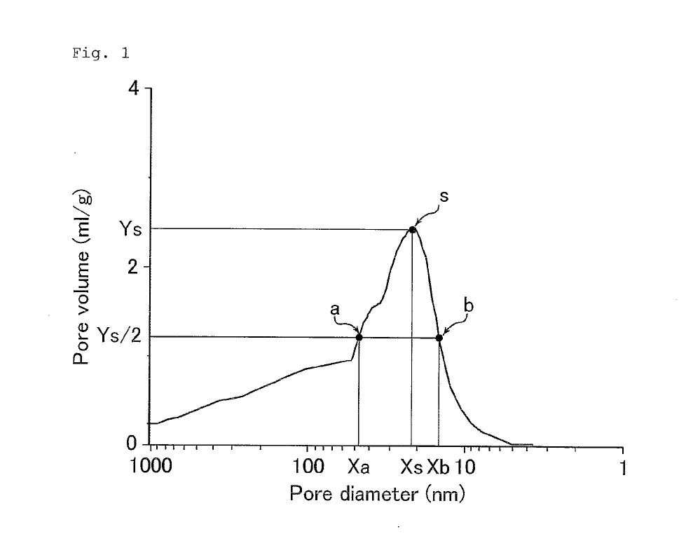

The pore distribution width W may be determined from a pore distribution curve as in FIG. 1 shown by the function of pore diameter (nm) and pore volume (mL/g). More specifically, the diameter Xs (nm) that gives the peak value Ys (mL/g) of the pore volume is recorded, the straight line of Y=Ys/2 is drawn, and then the points a and b at which the straight line intersects the pore distribution curve are obtained. When the abscissas (nm) of the points a and b are Xa and Xb (Xa>Xb), respectively, the pore distribution width W is equivalent to (Xa−Xb)/Xs.

The diameter Xs (nm) that gives the peak value Ys of the pore volume in the pore distribution curve of the finely-divided silica is preferably 10 nm or more, more preferably 15 nm or more, further preferably 18 nm or more, and particularly preferably 20 nm or more. Also, the diameter Xs is preferably 60 nm or less, more preferably 35 nm or less, further preferably 28 nm or less, and particularly preferably 25 nm or less. The diameter Xs in such a range can provide finely-divided silica excellent in dispersibility and reinforcement.

In the rubber composition of the present invention, the amount of the finely-divided silica is preferably 5 parts by mass or more, more preferably 10 parts by mass or more, and further preferably 15 parts by mass or more, per 100 parts by mass of the rubber component. If the amount is less than 5 parts by mass, improving effects of the finely-divided silica may not be sufficiently obtained. The amount of the finely-divided silica is preferably 150 parts by mass or less, more preferably 100 parts by mass or less, and further preferably 80 parts by mass or less, per 100 parts by mass of the rubber component. If the amount exceeds 150 parts by mass, processability may be deteriorated.

The rubber composition of the present invention may contain other types of silica in addition to the finely-divided silica. In this case, the total amount of silica is preferably 30 parts by mass or more, more preferably 40 parts by mass or more, and further preferably 45 parts by mass or more, per 100 parts by mass of the rubber component. Also, the total amount is preferably 200 parts by mass or less, more preferably 150 parts by mass or less, and further preferably 100 parts by mass or less, per 100 parts by mass of the rubber component. In the case that the total amount is less than the lower limit or more than the upper limit, the same tendency as described above concerning the amount of the finely-divided silica is shown.

The rubber composition of the present invention preferably contains a silane coupling agent. Conventionally known silane coupling agents may be used as the silane coupling agent, and examples thereof include: sulfide-type silane coupling agents such as bis(3-triethoxysilylpropyl)disulfide, bis(2-triethoxysilylethyl)disulfide, and bis(4-triethoxysilylbutyl)disulfide; mercapto-type silane coupling agents such as 3-mercaptopropyltrimethoxysilane, 3-mercaptopropyltriethoxysilane, and 2-mercaptoethyltrimethoxysilane; vinyl-type silane coupling agents such as vinyltriethoxysilane and vinyltrimethoxysilane; amino-type silane coupling agents such as 3-aminopropyltriethoxysilane, 3-aminopropyltrimethoxysilane, and 3-(2-aminoethyl)aminopropyltriethoxysilane; glycidoxy-type silane coupling agents such as γ-glycidoxypropyltriethoxysilane, γ-glycidoxypropyltrimethoxysilane, and γ-glycidoxypropylmethyldiethoxysilane; nitro-type silane coupling agents such as 3-nitropropyltrimethoxysilane, and 3-nitropropyltriethoxysilane; and chloro-type silane coupling agents such as 3-chloropropyltrimethoxysilane, 3-chloropropyltriethoxysilane, 2-chloroethyltrimethoxysilane, and 2-chloroethyltriethoxysilane. The silane coupling agent may be used either alone or as a combination of two or more kinds. Bis(3-triethoxysilylpropyl)disulfide is preferable among the above examples in view of the excellent processability.

The amount of the silane coupling agent is preferably 1 part by mass or more, and more preferably 2 parts by mass or more, per 100 parts by mass of the total amount of silica. If the amount of the silane coupling agent is less than 1 part by mass, processability tends to be deteriorated. The amount of the silane coupling agent is preferably 20 parts by mass or less, and more preferably 15 parts by mass or less, per 100 parts by mass of the total amount of silica. If the amount of the silane coupling agent exceeds 20 parts by mass, the effects obtained tend not to correspond to a cost increase.

Examples of the usable carbon black include, but not particularly limited to, GPF, FEF, HAF, ISAF, and SAF. The rubber composition containing carbon black can have higher reinforcement.

The nitrogen adsorption specific surface area (N₂SA) of the carbon black is preferably 30 m²/g or more, and more preferably 40 m²/g or more. An N₂SA of less than 30 m²/g may lead to insufficient reinforcement. The N₂SA of the carbon black is preferably 150 m²/g or less, and more preferably 140 m²/g or less. An N₂SA of more than 150 m²/g may make it difficult to disperse the carbon black in the rubber composition.

The N₂SA of the carbon black is determined in accordance with the method A of JIS K6217.

The amount of the carbon black is 15 parts by mass or more, preferably 20 parts by mass or more, and more preferably 25 parts by mass or more, per 100 parts by mass of the rubber component. The carbon black in an amount of less than 15 parts by mass tends to result in deterioration of breaking properties. Also, the amount of the carbon black is preferably 90 parts by mass or less, more preferably 80 parts by mass or less, and further preferably 70 parts by mass or less, per 100 parts by mass of the rubber component. The carbon black in an amount exceeding 90 parts by mass may reduce processability.

In addition to the above-mentioned ingredients, the rubber composition of the present invention may optionally contain other compounding ingredients generally used in production of rubber compositions. Examples of the compounding ingredients include zinc oxide, stearic acid, various kinds of age resistors, oils, waxes, vulcanizing agents, and vulcanization accelerators.

For example, process oil, vegetable oil, and mixtures thereof may be used as the oil. Examples of the process oil include paraffinic process oil, naphthenic process oil, and aromatic process oil. Examples of the vegetable oil include castor oil, cottonseed oil, linseed oil, rapeseed oil, soybean oil, palm oil, coconut oil, peanut oil, rosin, pine oil, pine tar, tall oil, corn oil, rice oil, safflower oil, sesame oil, olive oil, sunflower oil, palm kernel oil, camellia oil, jojoba oil, macadamia nut oil, and tung oil.

The rubber composition of the present invention may be produced by a usual method. That is, for example, the aforementioned ingredients are kneaded with an apparatus such as a Banbury mixer, a kneader, or an open roll mill and then vulcanized to produce the rubber composition.

The two-wheeled vehicle tire of the present invention may be produced by a usual method using the rubber composition. That is, an unvulcanized rubber composition with additives blended therein as needed is extruded and processed into the shape of a tire tread, assembled with other tire components and molded in a usual manner on a tire building machine so as to form an unvulcanized tire. Then, the unvulcanized tire is subjected to heating and pressing in a vulcanizer to obtain a two-wheeled vehicle tire. Alternatively, the two-wheeled vehicle tire may be produced according to STW technique in which rubber strips are wound to form a tire.

The two-wheeled vehicle tire of the present invention is suitably used as a two-wheeled motor vehicle tire and is especially suitably used as a motocross tire. The two-wheeled vehicle tire obtained according to the present invention can exhibit both good wet grip performance and good chunk resistance.

### EXAMPLES

The following will mention the present invention specifically with reference to Examples, but the present invention is not limited thereto.

The respective chemical agents used in Examples and Comparative Examples are listed below.

### NR: TSR20

SBR: Tufdene 4850 (SBR containing oil in an amount of 50 parts by mass per 100 parts by mass of SBR (solid), styrene content: 40% by mass, SBR solid content is shown in Table 1), produced by Asahi Kasei Corporation
Carbon black: SHOBLACK N220 (N₂SA: 111 m²/g), produced by Cabot Japan K.K.
Silica 1: Zeosil Premium 200 MP (CTAB specific surface area: 200 m²/g, BET specific surface area: 220 m²/g, average primary particle size: 10 nm, aggregate size: 65 nm, D50: 4.2 μm, proportion of particles exceeding 18 μm in size: 1.0% by mass, pore distribution width W: 1.57, diameter Xs giving pore volume peak in pore distribution curve: 21.9 nm), produced by Rhodia
Silica 2: Zeosil HRS1200 MP (CTAB specific surface area: 195 m²/g, BET specific surface area: 200 m²/g, average primary particle size: 15 nm, aggregate size: 40 nm, D50: 6.5 μm, proportion of particles exceeding 18 μm in size: 5.0% by mass, pore distribution width W: 0.40, diameter Xs giving pore volume peak in pore distribution curve: 18.8 nm), produced by Rhodia
Silane coupling agent: Si266 (bis(3-triethoxysilylpropyl)disulfide), produced by Degussa Oil: Diana process oil PS32, produced by Idemitsu Kosan Co., Ltd.
Wax: SUNNOC Wax, produced by Ouchi Shinko Chemical Industrial Co., Ltd.
Age resistor: NOCRAC 6C (N-(1,3-dimethylbutyl)-N′-phenyl-p-phenylenediamine), produced by Ouchi Shinko Chemical Industrial Co., Ltd.
Stearic acid: Tsubaki, produced by NOF Corporation
Zinc oxide: Zinc white #1, produced by Mitsui Mining & Smelting Co., Ltd.
Sulfur: Sulfur powder, produced by Tsurumi Chemical Industry Co., Ltd.
Vulcanization accelerator NS: Nocceler NS, produced by Ouchi Shinko Chemical Industrial Co., Ltd.

### Examples 1 to 8 and Comparative Examples 1 to 2

Chemical agents in amounts according to the formulation amounts shown in Table 1, except for the sulfur and the vulcanization accelerator, were mixed and kneaded in a Banbury mixer at 160° C. for four minutes to give a kneaded mixture. Thereafter, the sulfur and the vulcanization accelerator were added to the kneaded mixture and then mixed and kneaded with an open two-roll mill at 100° C. for two minutes to give an unvulcanized rubber composition.

Then, the produced unvulcanized rubber composition was formed into a tread shape and assembled with other tire components. Then, the assembled components were vulcanized at 150° C. for 30 minutes, and thereby a test tire (motocross tire) was produced.

In Examples and Comparative Examples, the amounts of the fillers (carbon black, silica) were adjusted so that the respective vulcanized rubber compositions have similar hardness.

The test tires were evaluated as follows. Table 1 shows the results.

### (Wet Grip Performance)

The test tires (rim size: 6.25×17, inner pressure: 290 kPa) were mounted on the front and rear of a motocross motorcycle (CRF 450R, produced by Honda Motor Co., Ltd.). The motocross motorcycle was run on a test course (wet road surface state) and the grip performance was evaluated by a test driver. The result of each test tire was expressed as an index based on the result of Comparative Example 1 being 100. The higher the index is, the better the wet grip performance is.

### (Chunk Resistance)

The test tires (rim size: 6.25×17, inner pressure: 290 kPa) were mounted on the front and rear of a motocross motorcycle (CRF 450R, produced by Honda Motor Co., Ltd.), and the motocross motorcycle was run on a test course (wet road surface state). After 15 km running, the chunk resistance was evaluated based on the size and the number of blocks chunked out of the test tire. The result of each test tire was expressed as an index based on the result of Comparative Example 1 being 100. The higher the index is, the better the chunk resistance is.

TABLE 1

| | | Comparative | | | | | Comparative | | | | |
|---|---|---|---|---|---|---|---|---|---|---|---|
| | | Example 1 | Example 1 | Example 2 | Example 3 | Example 4 | Example 2 | Example 5 | Example 6 | Example 7 | Example 8 |
| Formu- | NR | 30 | 30 | 30 | 30 | 30 | 60 | 60 | 60 | 60 | 30 |
| lation | SBR | 70 | 70 | 70 | 70 | 70 | 40 | 40 | 40 | 40 | 70 |
| (Part(s) | Carbon | 60 | 55 | 45 | 25 | 20 | 60 | 55 | 45 | 25 | 45 |
| by mass) | Black | | | | | | | | | | |
| | Silica 1 | — | 10 | 20 | 45 | 60 | — | 10 | 20 | 45 | — |
| | Silica 2 | — | — | — | — | — | — | — | — | — | 20 |
| | Silane | — | 0.8 | 1.6 | 3.6 | 4.8 | — | 0.8 | 1.6 | 3.6 | 1.6 |
| | coupling | | | | | | | | | | |
| | agent | | | | | | | | | | |
| | Oil | 10 | 10 | 10 | 10 | 10 | 10 | 10 | 10 | 10 | 10 |
| | Wax | 1.2 | 1.2 | 1.2 | 1.2 | 1.2 | 1.2 | 1.2 | 1.2 | 1.2 | 1.2 |
| | Age resistor | 2.4 | 2.4 | 2.4 | 2.4 | 2.4 | 2.4 | 2.4 | 2.4 | 2.4 | 2.4 |
| | Stearic acid | 1 | 1 | 1 | 1 | 1 | 1 | 1 | 1 | 1 | 1 |
| | Zinc oxide | 3 | 3 | 3 | 3 | 3 | 3 | 3 | 3 | 3 | 3 |
| | Sulfur | 1.0 | 1.0 | 1.0 | 1.0 | 1.0 | 1.0 | 1.0 | 1.0 | 1.0 | 1.0 |
| | Vulcan- | 2.0 | 2.0 | 2.0 | 2.0 | 2.0 | 2.0 | 2.0 | 2.0 | 2.0 | 2.0 |
| | ization | | | | | | | | | | |
| | accelerator | | | | | | | | | | |
| | NS | | | | | | | | | | |
| Evaluation | Wet grip | 100 | 105 | 110 | 115 | 115 | 90 | 95 | 100 | 105 | 105 |
| | performance | | | | | | | | | | |
| | Chunk | 100 | 100 | 100 | 90 | 95 | 105 | 105 | 105 | 100 | 95 |
| | resistance | | | | | | | | | | |

Table 1 indicates that compared with Comparative Examples 1 and 2, Examples 1 to 8 each containing a specific rubber component, a certain amount of carbon black, and silica having a predetermined value or more of CTAB specific surface area and a predetermined value or more of BET specific surface area achieved improvement in either wet grip performance or chunk resistance without greatly losing the balance between the two performances.

1. A tread rubber composition for a two-wheeled vehicle tire, comprising:
a rubber component,
silica, and
carbon black,
wherein the rubber component contains natural rubber, and styrene butadiene rubber and/or butadiene rubber,
the silica has a CTAB specific surface area of 180 m²/g or more and a BET specific surface area of 185 m²/g or more, and
the amount of the carbon black is 15 parts by mass or more per 100 parts by mass of the rubber component.

2. The tread rubber composition for a two-wheeled vehicle tire according to claim 1,
wherein the silica has an aggregate size of 30 nm or more.

3. A two-wheeled vehicle tire, comprising a tread produced using the rubber composition according to claim 1.

4. The two-wheeled vehicle tire according to claim 3, which is used as a motocross tire.
